(19) United States
(12) Patent Application Publication
(10) Pub. No.: US 2003/0235280 A1
(43) Pub. Date: Dec. 25, 2003

(54) Method and apparatus for network voice and data traffic monitoring and congestion management for diverse and converged networks

(76) Inventors: Reza Shafie-Khorasani, Westerville, OH (US); Michael Callaghan, Summit, NJ (US); Michael Allen Cleemput, Pataskala, OH (US); Brion N. Feinberg, Morganville, NJ (US); Duane W. Fletcher, Pataskala, OH (US); Richard D. Jordan, Gahanna, OH (US); Mark Vincent O'Riordan, Gahanna, OH (US); Umesh M. Rao, Freehold, NJ (US); John H. Rath, Lincroft, NJ (US); Donald E. Swartwout, Columbus, OH (US)

Correspondence Address: FAY, SHARPE, FAGAN,, MINNICH & McKEE, LLP, Seventh Floor, 1100 Superior Avenue, Cleveland, OH, 44114-2518, US

(21) Appl. No.: 10/179,682

(22) Filed: Jun. 25, 2002

(51) Int. Cl. H04M 15/00

(52) U.S. Cl. 379/112.01; 379/112.06

(57) ABSTRACT

This invention relates to a method and apparatus for network voice and data traffic monitoring and congestion management for diverse and converged networks. More particularly, the invention is directed to an interdomain congestion management architecture having the ability to analyze and correlate congestion problems across multiple domains, provide integrated network maps, tabular displays and/or reports and allow network managers, in appropriate circumstances, to navigate to a domain to implement corrective actions.

### BACKGROUND OF THE INVENTION

This invention relates to a method and apparatus for network voice and data traffic monitoring and congestion management for diverse and converged networks such as those comprising circuit-switched and packet data elements. More particularly, the invention is directed to an interdomain congestion management architecture having the ability to analyze and correlate congestion problems across multiple domains, provide integrated network maps, tabular displays and/or reports and allow network managers, in appropriate circumstances, to navigate to an appropriate domain to implement corrective actions.

While the invention is particularly directed to the art of traffic monitoring and congestion management and will be thus described with specific reference thereto, it will be appreciated that the invention may have usefulness in other fields and applications.

By way of background, the rapid evolution of the telecommunications industry has resulted in the convergence of voice and data networks over a myriad of diverse architecture and technological domains such as TDM (time division multiplexing), ATM (asynchronous transfer mode), SS7, wireless and IP (internet protocol). Service providers (SPs) are implementing converged networks and carrying voice services over both circuit switched and packet data networks. In this environment, establishing a voice call requires path setups in both the circuit switched and data packet networks and also involves the signaling network and edge equipment that convert the voice data from TDM format to packet format and vice versa.

In this regard, a variety of voice and data networks exist. For example, referring now to FIG. 1, a sample of network 100 is shown. The network configuration includes a PSTN (publish switched telephone network) TDM network 110, a TDM-IP edge domain, including networks 120 and 130, IP packet data core domain, including networks 140 and 150, and another PSTN 160. The actual network configuration (e.g. technology layering) for a given telecommunication service provider depends on the multitude and type of services offered by the service provider. So, for example, one SP may provide ATM as the core network, another a pure IP and another IP over ATM. In some networks, the data network could connect directly to the customer premises, bypassing the TDM and edge network domains.

FIGS. 2 and 3 illustrate still other examples of existing interfaces and network layers in multi-domain network architectures. Referring to FIG. 2, a network configuration 200 includes local exchange carriers 202 utilizing SS7 network element(s) connected to media gateways 204, which provide access to an edge network 206 of a suitable IP network 208. As shown, the network also includes appropriate media gateway controllers 210, signaling gateways 212, gatekeepers 214, databases 216 and feature servers 218. In a network of this configuration, the elements thereof are of differing domains and the interfaces between the elements use a variety of different protocols, all of which is well known to those versed in the art.

FIG. 3 illustrates a flow path for a call through a multi-layer network 300 that includes a central office 302 having a class 5 switch 304. The call is received in the central office 302 by the switch 304 and is passed on to a DCS 306. Through the DCS 306, the call is connected to an ATM edge router 308, which is connected to an ATM switch 310. Other components such as an ATM switch 312 and an OC-3 element 314 may also be a part of the flow through the central office. The call may be routed out of the central office through an OC-48 ring network 316 having connections to another OC-3 element 318. In many networks, communication lines are leased from other service providers. The flow path of the example call, through such leased lines, is represented by elements 320, 322, and 324 of FIG. 3.

The call ultimately reaches another central office 326. The central office 326 includes elements through which the call may be routed. For example, the call may be received in the central office 326 at OC-3 element 328 and transmitted to an ATM switch 330. The call then flows to an edge router 332, a DCS 334 and another class 5 switch 336.

It will be understood by those skilled in the art that the network flow path described above in connection with FIG. 3 represents, as representatively shown by the simple diagram 350, a multi-layer network having a SONET network 352 embedded within an ATM network 354, which is likewise embedded within a circuit switched network 356. Of course, a network that accommodates such a flow path includes a variety of domains and interfaces.

Existing network traffic management systems that manage networks, such as those shown in FIGS. 1-3, are domain specific and only capable of monitoring each domain separately. The lack of integration across different technologies has rendered the monitoring, management and control of a large communication network very complex and costly. A service provider has no ability in this environment to monitor voice traffic over the entire network, detect congestion in near-real time, or implement appropriate controls readily to inhibit or re-route traffic to relieve congestion. As should be apparent from the description of exemplary network configurations above, the inability to so operate in this environment is caused by the variety of domains (and all the appurtenant distinctions) and interfaces.

The problem is made more difficult because more than one vendor typically provides the network technologies. This situation creates network environments where one technology is provided by one vendor, and another technology by a different vendor. Technology providers supply distinctive element and network management systems to manage their own technologies, causing a creation of a “smoke-stack” network management environment to the service providers. The network management situation is further complicated by multi-vendor support within a single technology, and the need of a service provider to partition the management of a growing network. For example, the TDM voice network and its Traffic Management Systems can be regarded as one domain, while an ATM data network and its related management systems can be regarded as another domain.

One example of a congestion problem that is hard to diagnose and correct in this environment is a mass-calling event. A radio station advertises free concert tickets without first notifying the telephony service provider. The service provider's network may include a TDM domain to the customer premises, an IP packet data core domain where all traffic within the network is carried and an edge domain that converts TDM to IP on one end and back to TDM on the other. Mass-calls to the radio station cause congestion on the core IP domain. The management system monitoring the data network may detect the congestion but may not be able to find the cause. The management system monitoring the TDM domain may only know that most calls going over the IP domain are failing. Without having a network wide view, the time to analyze the problem increases and even then, each domain manager may take corrective actions that could make the congestion worse or be excessive and affect more calls than necessary. In these situations, time is of the essence. Delayed, incorrect or excessive corrective actions will likely cause loss of revenue and reduced customer satisfaction.

In a circuit switched network, congestion problems cause call connection failures but do not affect the quality of calls in progress. In data networks, congestion problems not only affect call setup but may also reduce the voice quality of calls in progress, increasing the chance for significant customer dissatisfaction.

Therefore, it would be advantageous to provide an appropriate network view and congestion management solution. The network managers would then be able to detect the source domain causing the problem, and even the specific problematic phone number (e.g. phone number of the radio station noted in the above example). Network managers would then only need to inhibit calls terminating at the specific phone number, thereby solving the network congestion without affecting dialing other numbers by customers. The time to analyze and correct the problem would also be significantly shorter.

Accordingly, the present invention contemplates a new and improved traffic monitoring and congestion management system that resolves the above-referenced interdomain difficulties and others.

### SUMMARY OF THE INVENTION

A method and apparatus for network voice and data traffic monitoring and congestion management for diverse and converged circuit switched and packet data networks are provided.

A traffic monitoring and congestion management system comprises an input module in communication with the application program interface and operative to receive alert information from the multiple domains—the alert information being generated as a result of an irregularity in the network, an analysis module operative to determine a root cause of the generation of the alert information based on a first predetermined set of rules, an action determination module operative to determine an action based on the root cause and a second predetermined set of rules, and an interface module in communication with the application program interface and operative to convey the action to the network to resolve the irregularity.

An advantage of the present invention is that it provides an architecture which allows telecommunication service providers to monitor the traffic over their entire network, detect congestion problems, identify the probable causes of the congestion and make corrective actions in near-real time.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is an illustration showing a sample of a prior art network architecture;

FIG. 2 is an illustration of another sample prior art network;

FIG. 3 is an illustration of another sample prior art network;

FIG. 4 is a block diagram illustrating a network architecture incorporating the present invention;

FIG. 5 is a block diagram illustrating an architecture according to the present invention;

FIG. 6 is a functional diagram illustrating preferred features of the present invention;

FIG. 7 is a functional diagram illustrating an exemplary preferred method of the present invention;

FIG. 8 is a block diagram illustrating an embodiment of an interdomain congestion manager according to the present invention;

FIG. 9 is a block diagram illustrating a network traffic patterning module according to the present invention;

FIG. 10 is a block diagram illustrating an alternative network traffic patterning module according to the present invention;

FIG. 11 is a block diagram illustrating a performance traffic management (packet domain) module according to the present invention;

FIG. 12 is a block diagram illustrating a performance traffic management (circuit switched domain) module according to the present invention;

FIG. 13 is a block diagram illustrating a performance traffic management (SS7 domain) module according to the present invention;

FIG. 14 is a performance traffic management (circuit switched domain) module according to the present invention; and,

FIG. 15 is a performance traffic management (circuit switched domain) module according to the present invention.

### DETAILED DESCRIPTION OF THE PREFERRED EMBODIMENTS

The present invention provides numerous advantages over that which is currently known in the art of communications. In this regard, the invention allows communication service providers to be able, without limitation, to:

1. Continuously monitor traffic over an entire network, including circuit switched, packet data, signaling and edge domains;

2. Detect traffic congestion and its source in near-real time; and,

3. Implement changes in the network in near-real time to reduce the congestion and allow the maximum number of calls to be successfully connected with appropriate level of quality, maximizing revenue and customer satisfaction.

The present invention is preferably implemented in a cross technology traffic and congestion management architecture that allows the service provider to accomplish the above objectives while taking into account the existing investment in technology specific management systems and their evolution. The integrity of the network management data is also preserved. The present invention comprises an improvement over current domain traffic management systems to allow handling of new network element types and interfaces in their respective domains, implement traffic management systems to handle new technology domains and introduce an inter-domain congestion management (IDCM) system.

The IDCM system has the ability to analyze and correlate congestion problems across multiple domains, provide integrated network maps, tabular displays, and/or reports and allow network managers, in appropriate circumstances, to navigate to the appropriate domain to implement corrective actions or controls. As a consequence, the invention provides similar naming schema for the physical and virtual network connectivity data across all domains.

In addition, the proposed architecture preferably assists the service provider in solving the following business problems. For example, network performance may degrade substantially during “unusual” network events (unusual loads, network failures, disasters). The service provider maintains reasonable performance during these events with the implementation of the present invention. Along these lines, congestion management allows the service provider to maintain, improve, and, in some cases, optimize network performance during periods of these unusual events (excess traffic, failure of network capacity).

Moreover, by constantly identifying network performance problems, the problems can be analyzed and addressed on a regular basis, which increases the overall network performance over time, improving customer satisfaction and service revenue. Ability to sectionalize the problem (including indicating which domains are the cause of the problem) allows the network managers to use other systems or processes to “correct” the problem. In addition, the ability to perform utilization management allows the service provider to balance network investment expenses with network quality of service and thus improve network utilization.

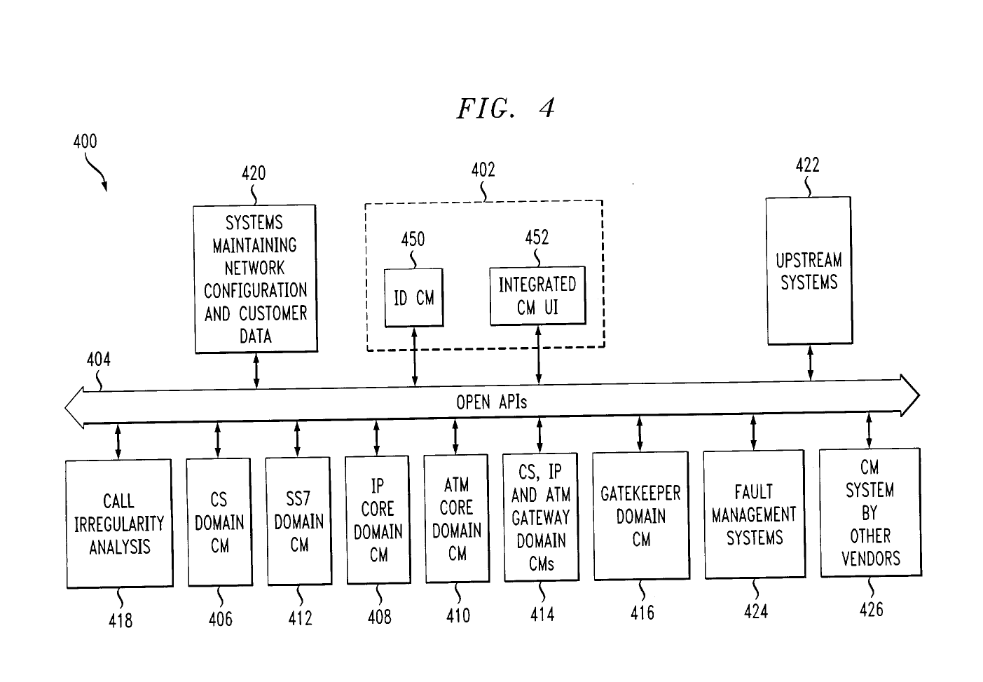

Referring back now to the drawings wherein the showings of FIGS. 4-15 are for purposes of illustrating the preferred embodiments of the invention only and not for purposes of limiting same, FIG. 4 provides a view of the overall preferred system according to the present invention. As shown, a network 400, including a variety of domains, comprises an inter-domain congestion management (IDCM) system 402 according to the present invention. Significantly, the inter-domain congestion management system 402 includes an inter-domain congestion manager 450 and an integrated congestion management user interface 452. The interface 452 is preferably a graphical user interface (GUI).

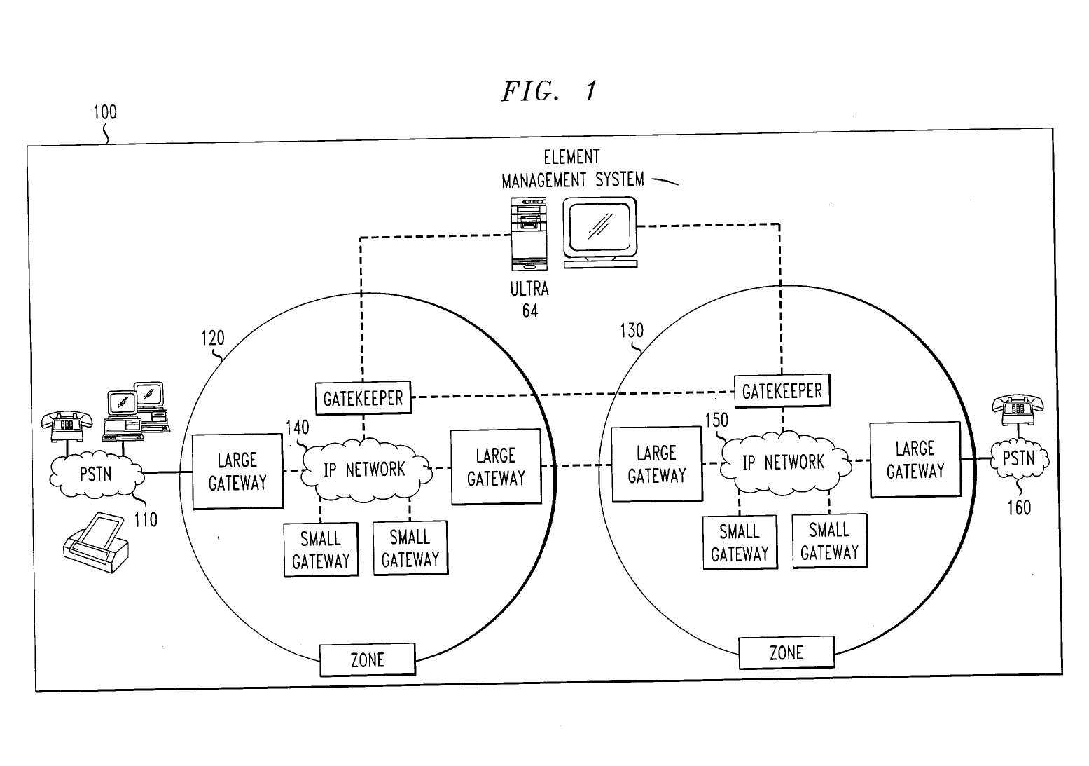

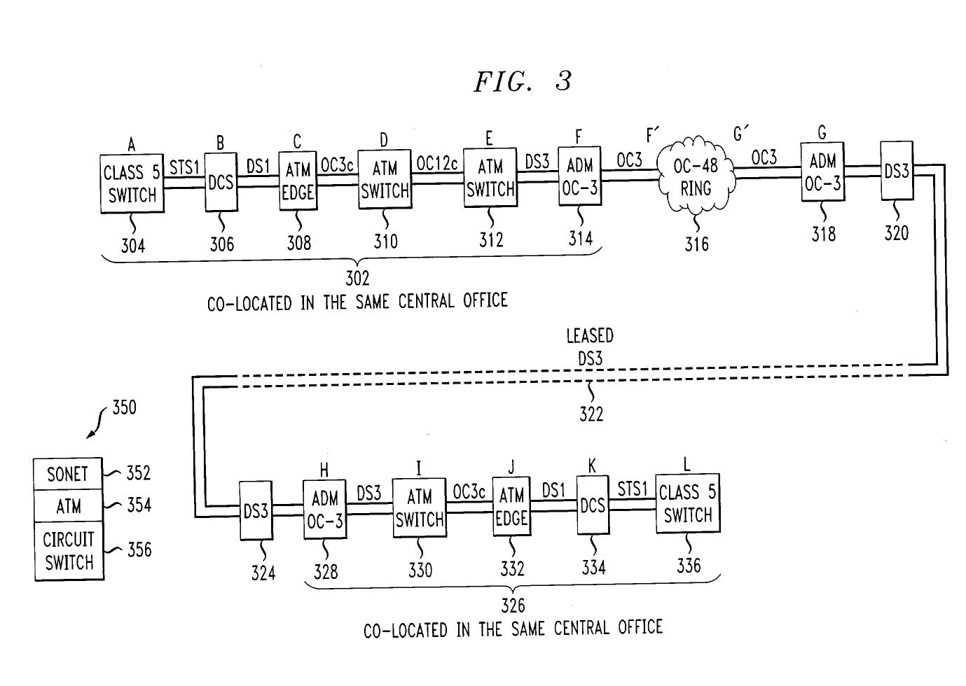

It should be understood that the network 400 illustrated in FIG. 4 is merely an example of a network into which the present invention may be incorporated. The present invention may also be incorporated in or applied to a variety of network configurations, including but not limited to those illustrated in FIGS. 1-3. Those skilled in the art will appreciate that network configurations are a function of a variety of factors including the network elements used, existing infrastructure and architecture, the intended purpose of the network, and the preferences of those designing the network. It will be further appreciated that, although the representation of the network 400 differs from the representations of FIGS. 1-3, the present invention is nonetheless applied to address the same or similar problems discussed in connection with those figures and others.

As shown, the example network 400 also includes an application program interface (API) 404 having connected thereto 1) a circuit switched (CS) domain congestion management (CM) system 406, 2) an internet protocol (IP) core domain congestion management (CM) system 408, 3) an asynchronous transfer mode (ATM) core domain congestion management (CM) system 410, 4) an SS7 domain congestion management (CM) system 412, 5) a gateway domain congestion management (CM) system 414, and 6) a gatekeeper domain congestion management (CM) system 416. The congestion management (CM) systems are more generally known as performance (or packet, if appropriate) traffic management (PTM) systems and possess the function of identifying and monitoring congestion problems in the particular domain in which the PTM system resides. Moreover, the application program interface 404 is preferably a publishable, open API such as CORBA, XML, LDAP or DCOM.

Also communicating with the interface 404 is a call irregularity analysis, or network trouble patterning (NTP), system 418. This system may take a variety of forms and have a number of functions, as those skilled in the art will appreciate; however, the primary function of the system(s) is to identify irregularities in the services offered over the network.

While only representatively shown for clarity and brevity, the example network 400 also includes connections to 1) systems 420 for maintaining network configuration and customer data, 2) upstream systems 422, 3) fault management systems 424, and 4) other congestion management systems 426 that are provided by other vendors. However, notably, the fault management systems represented at block 424 are dispersed throughout the network and correspond to each different domain and/or network element, as will vary from network to network. That is, each domain preferably includes at least one network fault management (NFM) system to recognize and manage physical faults, e.g. cut lines, open doors at cell sites, etc., that may occur in the domain.

It should be understood that many of the components of the network 400 are well known in the art. It should be further apparent that the primary aspect of implementation of the present invention is the provision of the inter-domain congestion management system 402. Nonetheless, to implement the present invention most effectively, various aspects of the known elements of the network may also require modification to accommodate the features of the present invention. For example, fault management systems may be provided for certain domains that otherwise do not possess adequate fault management capabilities. In addition, domain specific management may need to be added to existing architecture in certain circumstances to implement the present invention.

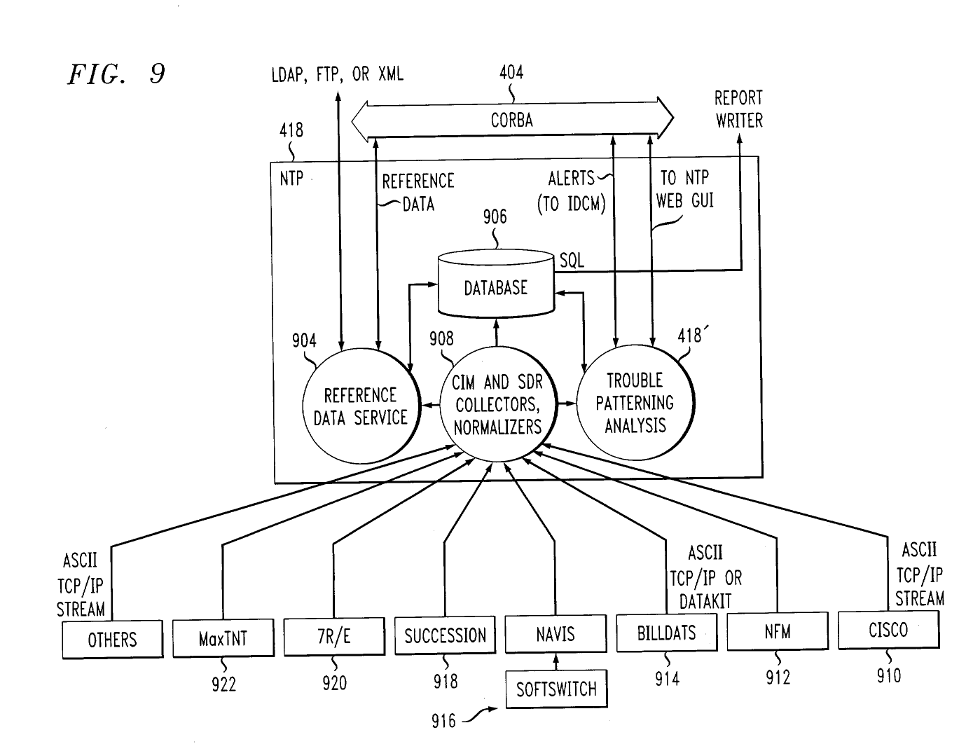

Thus, the present invention includes not only the addition of an inter-domain congestion management system 402 (including all appropriate interfaces and integration technologies as will be discussed in greater detail below in connection with FIGS. 9-15) to known network configurations but also the enhancement of existing domain management systems, the addition of new domain management systems (where appropriate) and the provision of new control methods to implement traffic changes in data networks.

In operation, the domain specific congestion management, or CM, systems 406, 408, 410, 412, 414, 416 and 426 collect performance and fault data from their respective domains (directly from network elements or known element management systems), perform near-real time analysis and display the results on graphical map or tabular displays, as is known in the art. Then, in accord with the present invention, the appropriate data relating to possible congestion is transmitted to the inter-domain congestion management (IDCM) system 402, namely, the manager 452.

In addition, a trouble patterning, or calling irregularity analysis, system 418 collects call failure and call detail records from network elements and performs statistical analysis to detect call and failure patterns according to known techniques. Again, appropriate results are displayed, as is known, and also transmitted—in the form of, for example, alert information—to the inter-domain congestion management system 402 in accord with the present invention. Likewise, when appropriate, the fault management systems 424 also send data on physical difficulties in the network when requested by the system 402.

In this way, the inter-domain congestion management system 402 collects congestion related data, such as alert information, from each domain management system, and the other traffic management systems provided by other vendors. The system 402 then correlates this data with other suitable data and performs appropriate analytical analysis to detect and help specify the domain where the problem originated. Appropriate action is then taken by the system or a user to correct the irregularity.

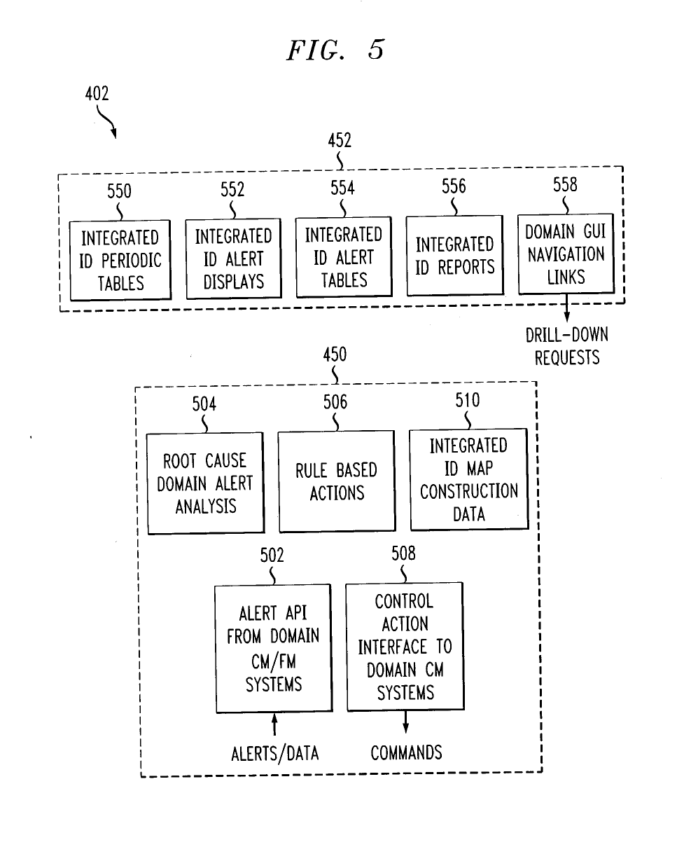

Referring now to FIG. 5, the inter-domain congestion management system 402, including the manager 450 and user interface 452, is illustrated. More particularly, the manager 450 includes an input module 502 in communication with the interface 404. The input module 502 is operative to receive alert information, or alerts, and other appropriate data from network elements across the multiple domains of the network. The alert information is typically generated as a result of an irregularity in the network and sent by appropriate network element (e.g. NTP system 410) to the input module 502.

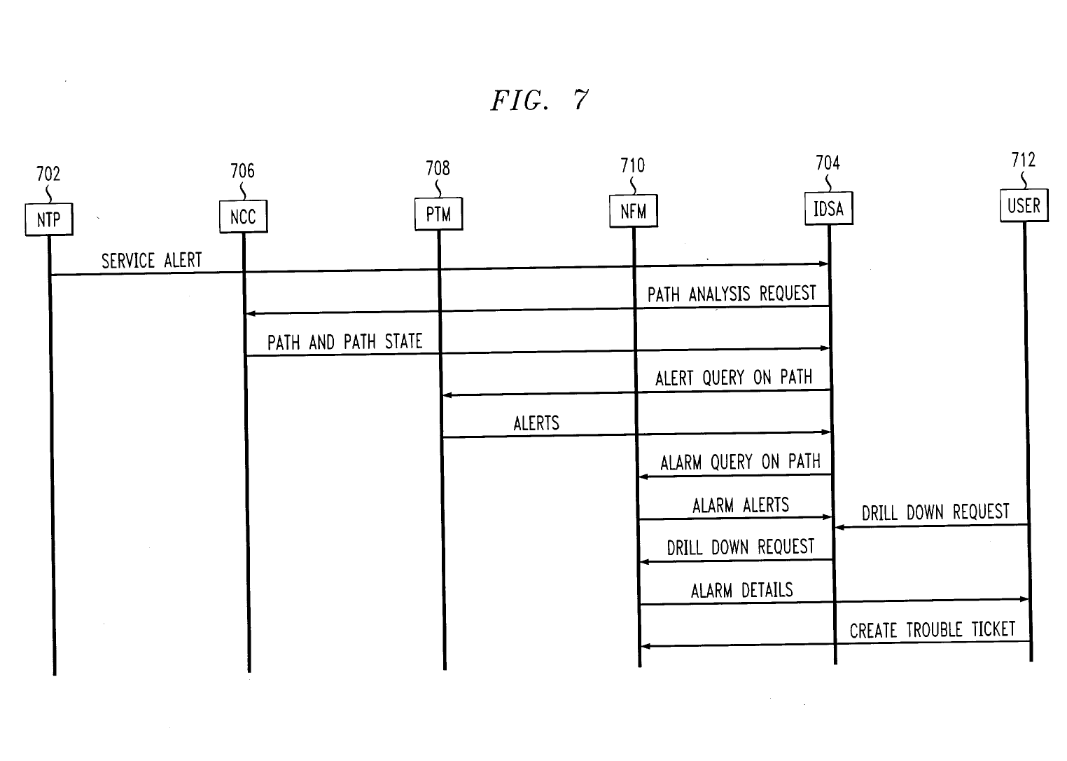

Once the alert or alerts are received from the network, through the input module 502, an analysis module 504 determines a root cause of the generation of the alert information based on a first predetermined set of rules, or procedures or steps, that are stored in the system. As will be more particularly described in the example of FIG. 7, the process for determining the root cause of a problem may require the querying of different domain specific CM systems in a manner according to the first predetermined set of rules.

Of course, it is to be appreciated that these rules, or procedures or steps, may vary from system to system. It should also be understood that these rules may reflect and generally take the form of the steps and processes that are undertaken by the domain specific CM systems—except on an interdomain basis. While the rules may vary, a common objective of the rules is to determine the root cause of an irregularity on an interdomain basis. Preferably, this is accomplished by querying specific paths to gather data or information on status, alarms, alerts, congestion, faults, etc.

An action determination module 506 then determines which action should be taken to resolve the irregularity based on the root cause and a second predetermined set of rules which are also stored in the system. An interface module 508 is further provided to the manager to convey the action or commands, determined by the action determination module 506, to the network to resolve the irregularity.

The manager 450 also includes an integrated inter-domain map construction data module 510 which generates for the system a map of the network and the irregularity based on the information determined by the analysis module 504 and action determination module 506. It is to be appreciated that the construction module 510 includes appropriate tools to construct a suitable map so that the problem can be visually analyzed by users of the system through the interface 452. The associated techniques are well known to those skilled in the art.

The user interface 452 of the system 402 includes a periodic table generation module 550, an alert display module 552, an alert table generation module 554, a report module 556 and a navigation and linking module 558. It is to be appreciated that the modules 550, 552, 554 and 556 generate various displays of the data with respect to the irregularities of the network according to the preference of the user. Any known display techniques are suitable for this purpose.

However, the navigation and linking module 558 provides useful functionality to the user to navigate through the network virtually. This allows the user to identify the problems and observe the action taken by the system or command the system to take action to resolve an irregularity in the system. In particular, a user will be provided with the tools to click on, or select, a portion of a map constructed by module 510 and obtain details about a particular irregularity. In order to do so, the system 402 links through the interface 404 to the appropriate domain specific CM system. To do so, the system preferably uses common schema and reference data along with common security information throughout the network. In this way, the user, through the use of a “drill-down request”, can view the information about the irregularity from specific network elements for either observation purposes or analysis purposes. Then, the user can direct the system, through the interface 452, to take action or further action as is appropriate.

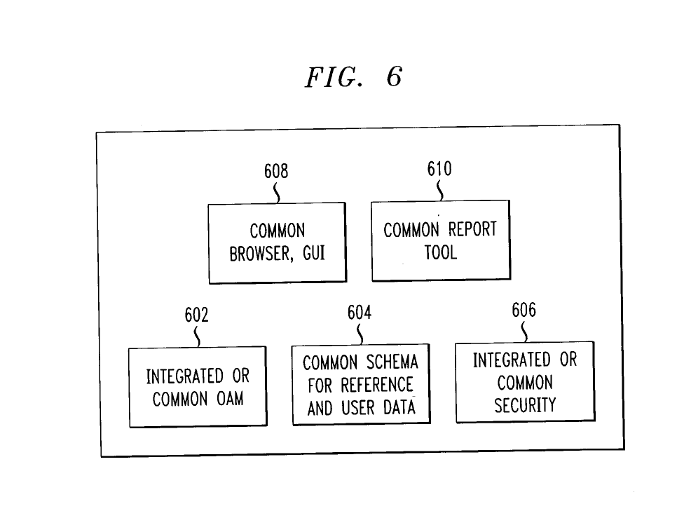

Referring now to FIG. 6, a functional block diagram of the preferred capabilities of the system 402 is shown. In particular, the preferred system 402 includes an integrated or common operation, administration and maintenance (OAM) system 602 so that domain specific CM systems across the various domains are capable of responding to common commands. For example, in the preferred embodiment, the integrated or common OAM system 602 utilizes common commands for backup storage of the system and of the domain specific CM systems irrespective of the domain in which they reside. The techniques for operations, administration and maintenance are well known in the art. The application to the present invention provides for commonality between the domain elements.

The system also preferably includes a module 604 useful to implement common schema for reference and user data. The implementation of this function is preferably accomplished through mapping of names, references and data related to network elements so that common terminology will allow for the most efficient operation of the system. Appropriate tables are stored for the module 604 to accomplish this function. For example, a network element may be referred to as “network element 01” by one element of the network and as “network element 001” by another element of the network. The module 604 provides appropriate table and mapping information to ensure that the element is consistently recognized as the same element by the inter-domain congestion management system 402 irrespective to the precise identifier used.

An integrated or common security module 606 is also provided to the system 402. Like the use of common schema for reference and user data, integrated common security allows for cross-referencing and mapping between network elements so that common terminology and referencing is utilized. This is accomplished in the system through the use of tables and reference information stored in the module 606 and allows for the most efficient operation of the system.

As noted above, the user interface 452 allows for the navigation by the user through the network to observe, analyze and/or act upon irregularities in the network. To accomplish this, a common browser and graphical user interface 608 is preferably provided to the system. Likewise, a common reporting tool 610 is also provided to the system. Both of these tools 608 and 610 utilize components that are known in the art and are integrated so that any differences between known tools are transparent to the user. Such integration should be apparent to those of ordinary skill in the art.

It will be further appreciated by those skilled in the art that a primary objective of the present invention is to allow for proper traffic and congestion management. However, circumstances such as the configuration of the network, traffic on the network, and operation of each of the network components will dictate the specific form of the invention in any particular environment.

In this regard, an example of an implementation of the apparatus and method of the present invention will be described in connection with FIG. 7. This, though, is merely an example and the invention should not be construed to be limited to only this technique. Again, it will be understood that the implementation of the invention in any particular network may have varying results and step-by-step processes and/or rules which are utilized according to preferences of the designer, configuration of the network, and the operation of the individual network elements.

Referring now to FIG. 7, a network traffic patterning (NTP) device 702, such as the system 418 (FIG. 4), analyzes service alerts from the network elements in a particular domain to determine if the alerts warrant action. This process of analysis is well known in the art, however, according to the present invention, the network traffic patterning device 702 preferably sends a single alert (representing a variety of alerts that may have been received) of an irregularity to the inter-domain congestion management system 704. For example, the irregularity may be congestion in the network and that calls are consequently failing.

The system 704, which corresponds to the system 402 of FIG. 4, then, based on a predetermined set of rules or processes, queries a network configuration component (NCC) 706 as to the path related to the irregularity. The network configuration component 706 then provides the information regarding the path and the state of the path to the system 704. For example, the path related to the irregularity may extent from point A to point B, then from point B to point C, etc. It is to be appreciated that the network configuration component is preferably formed as a part of the system 704.

The system 704 subsequently (again, based on a predetermined set of rules) queries a performance traffic management (PTM) system 708 as to any problems that may be occurring on the path(s) of interest. This query generally relates to whether congestion problems are occurring in the path(s). The performance traffic management (PTM) system is a domain specific CM system such as one of the congestion managers 406, 408, 410, 412, 414, and 416 of FIG. 4.

In response, the performance traffic management system 708 sends back to the system 704 information on congestion on the requested paths. For example, the PTM system 708 may send back information to the system 704 that there is congestion between points A and B and between points B and C.

Next, the inter-domain congestion management system 704, based on the rules, queries the network fault management (NFM) system 710 corresponding to the appropriate domain on whether any physical faults have occurred on the requested paths. In response, the network fault management system provides alarm information back to the inter-domain congestion management system 704 with respect to such physical faults. For example, the NFM system 710 may return information that a line was cut on the path from point B to point C or that a door was opened on a cell site within the path from point B to point C.

This information is then used to determine the root cause of the irregularity in the system as described in connection with FIGS. 4, 5 and 6 to determine an appropriate action to be taken. Of course, as noted above, this action may encompass a variety of different scenarios based on a second set of predetermined rules and the root cause; however, in this case, a user is provided with the information. The user 712, then implements a drill-down request through the system to obtain detailed information about the irregularity. The details of the alarm are then provided—through the user interface 452—to the user by the network component which is the root cause of the problem. In this example, the user then creates a trouble ticket to be sent to the appropriate repair department or technicians through the system 402 so that appropriate action can be taken. For example, if a network element was provisioned incorrectly to route calls to an invalid location, the trouble ticket would comprise a request to correct the provisioning error. Likewise, if a line was cut, a service call to the particular station would be ordered by the trouble ticket.

Alternatively, the user may only accomplish a drill-down request to observe the details of the alarm and the action taken by the system to correct the problem. For example, the system, based on its rule-based actions, may simply reroute traffic or direct that call to a particular phone number be limited to solve a particular congestion problem.

As previously set forth, the types of rules that are applied in a specific system according to the present invention may vary depending on the configuration of the system and the objectives of the designers and/or users. As such, a variety of categories of rules may be implemented. Among such categories are the following:

NUMERICAL ANALYSIS RULE—This type of rule generates analysis alarms if a number of selected and related alarms meet a preset threshold.

SUPPRESSION RULE—This type of rule identifies root cause alarms and their associated sympathetic and suppressible alarms.

PERCENT FAILURE ANALYSIS RULE—This type of rule generates analysis alarms if the relative numbers of different alarm types meets a threshold. This also applies to missing alarm types where one alarm type does not exist.

CONDITION ANALYSIS RULE—This type of rule generates analysis alarms for each alarm passing tests.

INTERDOMAIN CORRELATION RULE—This type of rule provides analysis of events from multiple domains to determine probable root-causes of problems. Topological relationships may be used here.

PREDEFINED ACTION—This type of rule is set up to automatically perform an action such as generating a new alarm, clearing an alarm, sending e-mail or pager calls, running a program or command, adding a control to route or inhibit certain network traffic or creating a trouble ticket.

As will be appreciated, these types of rules can be suitably utilized as the first predetermined set of rules or the second predetermined set of rules, as will be dictated by the system implemented.

A least one set of circumstances implementing rules as contemplated by the invention is illustrated in connection with FIG. 7. However, it is to be appreciated that different circumstances may dictate the use of different types of rules. Implementation of rules depends on the system to which the rules are applied as well as the objectives of the designers and/or users of the system. To that end, the following examples illustrate circumstances where particular rules may be applied. This description of examples should in no way be construed as limiting the invention. Rather, these examples should be construed as merely an illustration of the invention.

### EXAMPLE A

It would be useful to prioritize equipment failure alarms by comparing traffic problems that may be related to each failure. The following points illustrate these circumstances.

Where two (2) distinct equipment failure alarms have been collected by NFM for equipment A & B, it is important to know which one should be addressed & repaired first.

To do so, NTP is checked and it is determined whether there are traffic anomalies related to the areas where each failed equipment is situated (i.e., is the number of call irregularity messages (CIMs) much lower or much higher than normal for each area?).

Suppose Area A has much higher CIMs while number of CIMs in area B is close to historic levels.

In this case, the severity of equipment A's alarm can be increased and additional information can be added to the alarm suggesting that this failure may be affecting network traffic. Equipment B may be a backup device or may have been configured for high availability and a backup route or device may have taken over, insuring that network traffic is not affected.

### EXAMPLE B

To determine if different problems on the network are related, the following points may be considered.

Specifically, following example A, it would be useful to determine if the equipment failure A and the higher CIM rate are related.

To do so, the rule requires the system to check when the equipment failure alarm was received in NFM and then check NTP to find when the rate of CIMs surpassed historical levels.

If the equipment failure alarm was received prior to the CIM anomaly in NTP, we can deduce that the equipment failure caused the CIM anomaly.

If the CIM anomaly had started more than a few minutes before the equipment failure alarm (there might have been a delay in detecting the failure and generating the alarm), then the two problems are most likely not related.

This information can then be added to the contents of both the equipment failure alarm and the CIM anomaly alarms.

This will reduce the amount of analysis that the network managers must do manually.

### EXAMPLE C

It would also be useful to lower the priority of alarms that need not be addressed immediately. To do so according to the present invention:

Assume NTM starts reporting that traffic on a certain route has exceeded predefined thresholds. An alarm is generated. Meanwhile, there are other problems in the network that require network managers immediate attention. Should network managers be concerned about this new problem?

To address this situation, a rule requires the system to check NTP to see if the number of CIMs is exceeding historic norms for calls that originate or end on the network elements at the two ends of this route.

Check NFM and see if there are any new equipment failure or loss of signal alarms for equipment on the same path.

Assume there are no new anomalies reported by NTP and NFM.

We can assume that although the traffic has reached the threshold, the network is continuing to handle the load and no immediate action is required. The severity of NTM's performance issue can be lowered and the analysis information specified above can be added to its description.

### EXAMPLE D

Normally, CIMs are caused by mass-calling to a certain phone number. It would be useful to have a rule to specify if certain CIMs are caused by equipment failure (which must be dealt with differently). To do so, the following should be considered.

Based on historic analysis, assume that CIM alarms on different network element are generated one or two at a time if the problem is related to a mass-calling event (it takes more than 60 seconds for the congestion to affect other parts of the network).

A rule according to the present invention requires the system to count NTP's CIM related alarms that are not reporting problems on the same network elements within a certain time interval (i.e. 60 seconds).

If the count goes higher than 3, it is determined whether any hardware related alarms have been reported by NFM during the last 120 seconds.

If so, there is a high likelihood that these two problems are related.

A new alarm is created that specifies the information gathered above and suppresses the other alarms.

### EXAMPLE E

Consider a situation where two distinct cable cuts have occurred. Network managers on NFM, NTP and NTM will all be overwhelmed by the number of alarms that are generated. Other problems on the network (i.e. a mass-calling event) cannot be analyzed or even noticed within the mass number of alarms that are generated. NTM is reporting network traffic congestion problems everywhere. NTP is reporting CIMs everywhere. NFM is collecting alarms on every circuit that was routed over the cut cables. The total number of alarms may exceed 100 to 1000, most of which are of high severity. To deal with this situation, the following illustrates a suitable rule.

Create a root-cause analysis rule in NFM that finds the equipment reporting loss of signal alarms closest to the actual cut (on both sides of the cable cut with all other circuits reporting problems riding on top of that circuit). Suppress all other equipment alarms except the 2 (for 2 cable cuts).

Correlate CIM alarms with the root cause cable cut alarms. Create a rule that assumes if CIMs were generated within 60 seconds of the cable cut, all CIMs related to the same network elements which were generated after the cable cut should be suppressed by that cable cut alarm. Do the same for network congestion alarms generated by NTM.

Add predefined controls to inhibit traffic on circuits riding on the cut cables.

Now, the number of alarms displayed are significantly reduced, allowing network managers to see mass-calling problems that are unrelated to the cable cuts. Automatically entered controls will reduce congestion until network managers can decide on a more detailed action plan.

### EXAMPLE F

Consider that network element A has failed. The failure is such that the network element cannot generate or report a failure alarm (the equipment has died silently). Meanwhile, other elements in the network start reporting communication failures for routes that are connected to or go through the failed network element. The number of alarms generated can reach 20-100. Normally, network managers must analyze each of these alarms and try to find what is causing each one.

A rule requires the system to find that all these alarms are of the same type and are reporting problems to the same network element. A new analysis alarm can be created to report that network element A is isolated (either failed or completely disconnected from the network). All other alarms can then be suppressed by this new analysis alarm.

As noted above, these network applications and their separable modules (described in connection with FIGS. 4-7) interface with each other and other systems according to the present invention using publishable open APIs such as CORBA, XML, LDAP, and DCOM. As such, the interfaces between components and modifications to known components are a part of preferred systems.

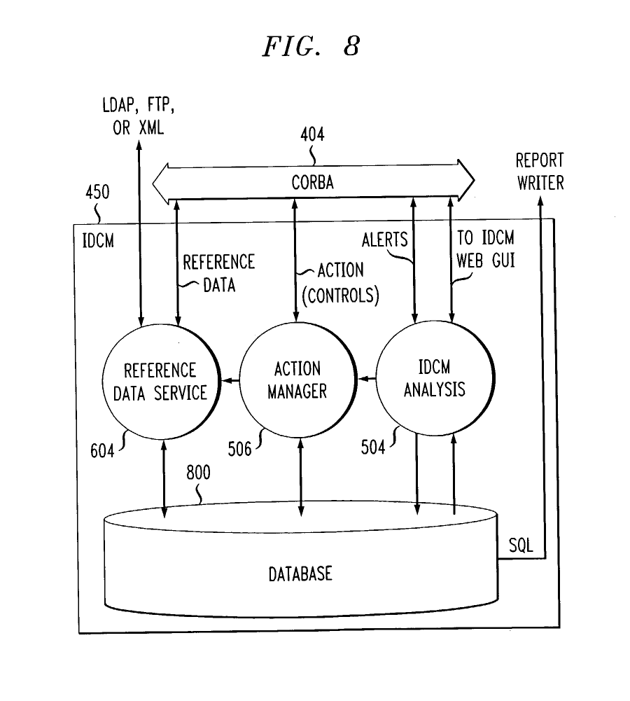

More particularly, referring now to FIG. 8, an inter domain congestion manager 450 is illustrated to supplement the showings of FIGS. 4, 5 and 6. Significantly, the module 450 includes an analysis module 504, a rule-based action module 506, a reference data service module 604 and a database 800. The analysis module 504—which determines the root cause of congestion—communicates with the application program interface 404 through an interface that allows alerts to be conveyed between the module 504 and the interface 404. The analysis module 504 also communicates with the graphical user interface 452 through the interface 404. In addition, the action determination module 506 communicates actions or controls to the network through the interface 404. The reference data service module 604 communicates reference data to the interface as well. As shown, these modules communicate with one another and with the database 800 to implement features of the present invention. The database 800 preferably stores the first predetermined set of rules to determine the root cause by the module 504. Further, the database 800 stores the second predetermined set of rules to assist the action determination module 506. Also, the database stores reference data, periodic data and alert data according to the present invention.

It is to be appreciated that the modules with like reference numerals to those described in connection with FIGS. 4-7 comprise structure and functionality similar to the elements of those Figures. However, it is to be appreciated that the invention may be implemented in a variety of different configurations having different functionality.

FIGS. 9-15 illustrate a variety of the components useful in a system according to the present invention. It is to be appreciated that the components illustrated are merely exemplary and their use, function, and configurations (absent the modifications as a result of the present) are well known; however, in their preferred form according to the present invention, the components utilize an interface(s) for purposes of exchanging information on alerts and reference data.

Referring now to FIG. 9, a network traffic patterning module 418 (similar to that shown in FIG. 4) is illustrated. Specifically, trouble patterning analysis module 418′ provides alerts to the module 450 through the interface 404. The trouble patterning analysis module 418′ also communicates with the graphical user interface. A reference data service module 904 is provided to the system to communicate reference data to the interface 404.

Also shown in FIG. 9 is a database 906 which stores reference data and alert information and a collector/normalizer 908 incorporated within the network traffic patterning module 418. Also shown are a variety of network elements connected to the module 908, such network elements having configurations and functions which are well known to those skilled in the art. For example, a switch 910, a network fault management system 912, a billing and data system 914, further switch configuration 916, a succession module 918, still another switch 920, and a max TNT 922 are illustrated.

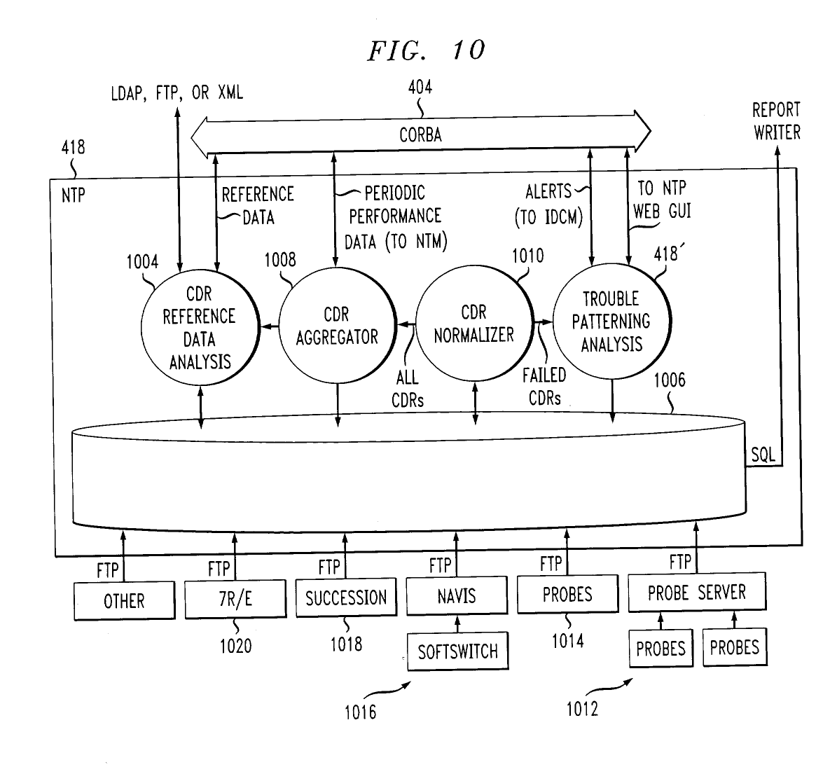

FIG. 10 illustrates a further embodiment of a network traffic patterning module 418 having a trouble patterning analysis module 418′ included therein. In this embodiment of the network traffic patterning module, the trouble patterning analysis module 418′ communicates alert information to the interface 404. In addition, a reference data analysis module 1004 is included in the system to provide reference data to the other components of the system, including the manager 450, through the interface 404.

A module 418 also includes a database 1006 to store reference data and alert information, a call detail record aggregator 1008, and a call detail record normalizer 1010. Similar to the component illustrated in FIG. 9, the network traffic patterning module 418 is also connected to a variety of network elements, such network elements being well known in the art. For example, a probe system 1012, a probe element 1014, a switch configuration 1016, a succession module 1018, and a further switch 1020 are connected to the database 1006.

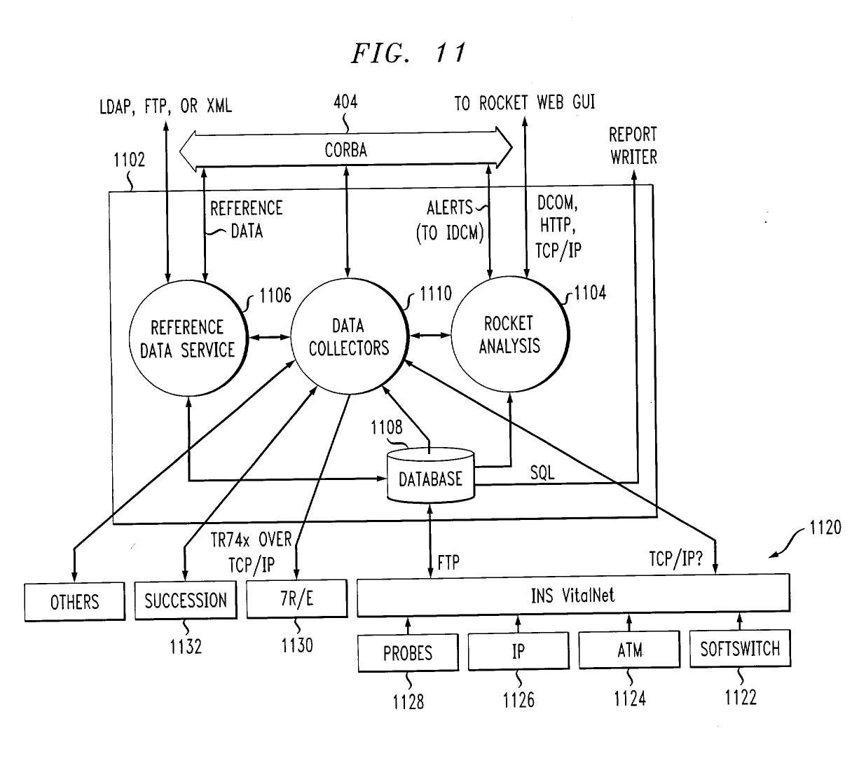

In FIG. 11, a performance traffic management module 1102 is illustrated. Such a module operates in the packet domain and may take the form of modules 408 and 410 shown in FIG. 4. Significantly, a performance traffic management module 1102 includes an analysis module 1104 to provide alerts to the manager 450 through the interface 404 and a reference data service module 1106 which provides reference data through the interface 404. A database 1108 for storing reference data and alert information and a data collector 1110 are also provided to the module 1102.

The module is also connected to a variety of network elements. These elements have configurations and functions which are well known to those skilled in the art. For example, module 1102 may be in communication with a network 1120 having incorporated therein switches 1122, 1124, 1126, and 1128. Also connected to the module 1102 may be another switch 1130 and a succession module 1132, as well as other network components.

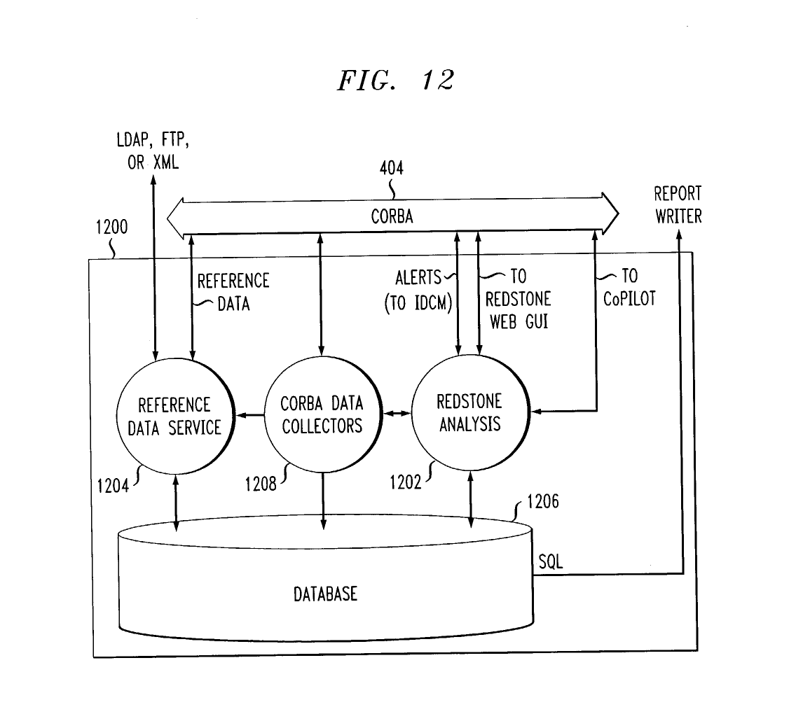

As shown in FIG. 12, a performance traffic management module operating in a circuit switched domain may be incorporated into the network into which the present invention is applied. As shown, a circuit switched, performance traffic management module 1200 includes an analysis module 1202, for providing alerts to the inter domain congestion manager 450 and a reference data service 1204 for providing reference data through the interface 404. It is to be appreciated that the circuit switched domain PTM 1200 may take the form of module 406 in FIG. 4. Also shown in FIG. 12 are database 1206 for storing reference data and alert information and data collectors 1208.

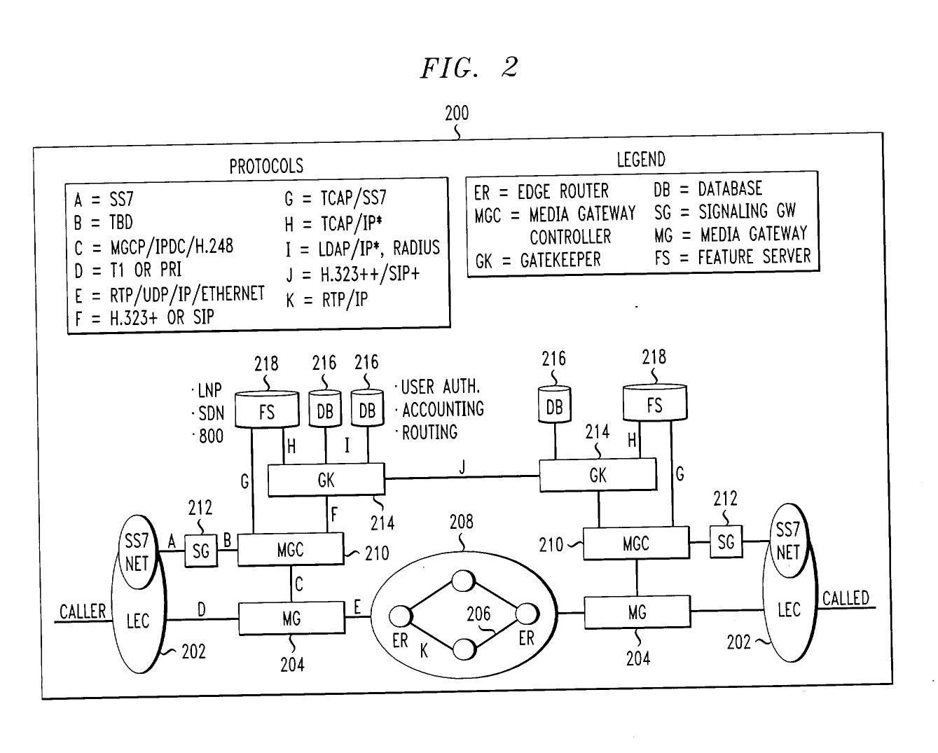

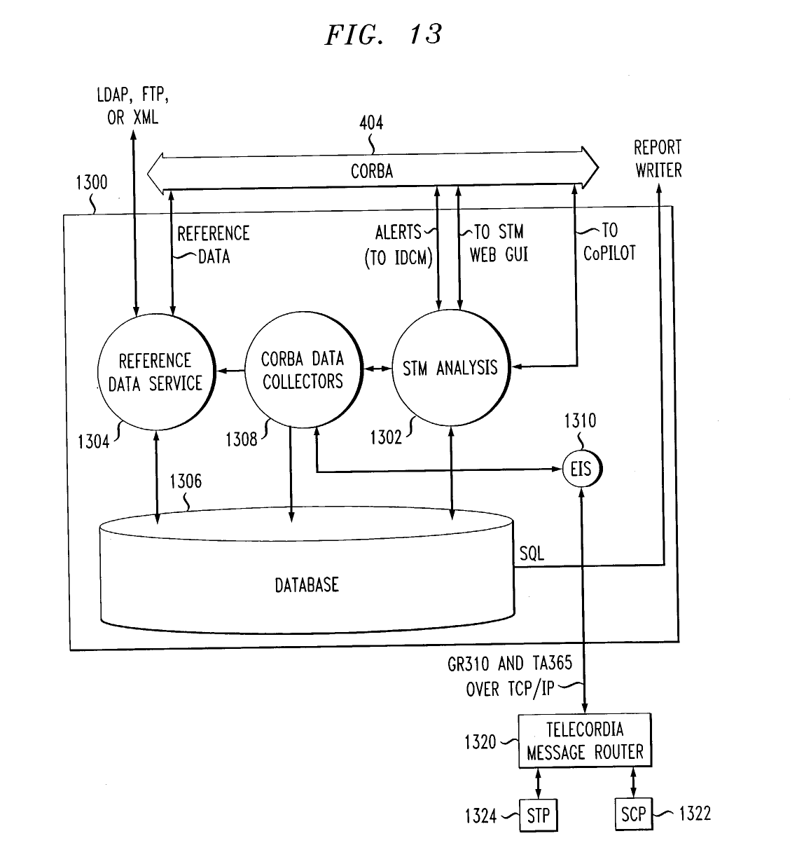

Referring now to FIG. 13, a performance traffic management module focussed on an SS7 network is illustrated. The module 1300 corresponds to module 412 of FIG. 2. Most significantly, module 1300 includes an analysis module 1302 for providing alert information to the manager 450 through the interface 404 and a reference data service module 1304 for providing reference data to the network through the interface 404. Also included within the module 1300 are a database 1306 for storing reference data and alert information, data collectors 1308, and an element information system 1310. Various components, the configuration and operation of which are well known in the art, may be connected to the module 1300. For example, a message router 1320 may communicate with the module 1300. Further, a service control point 1322 and an STP 1324 may be connected to the router 1320.

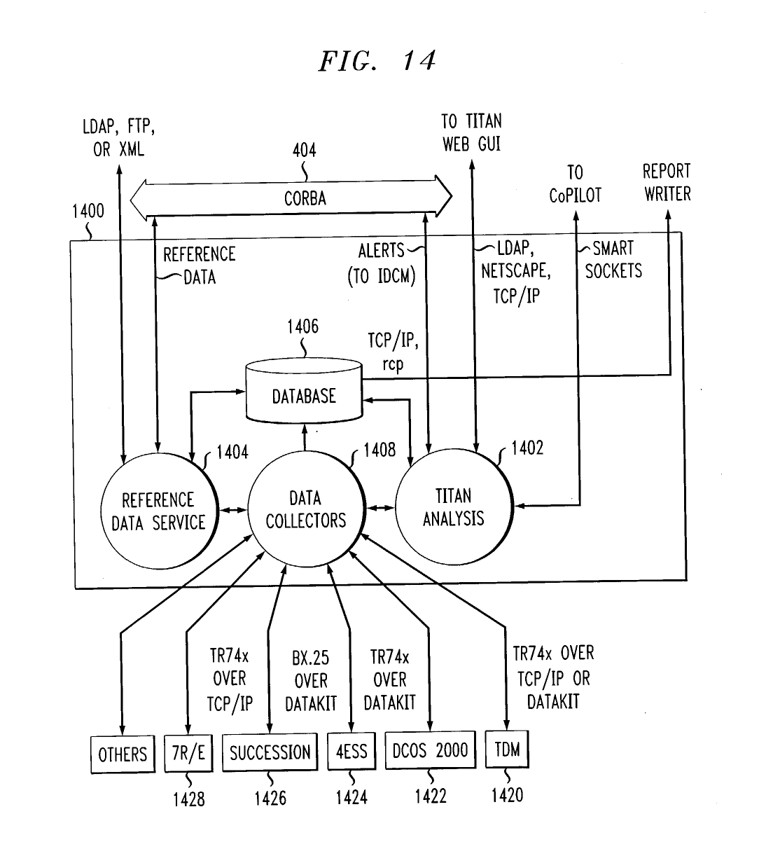

FIG. 14 shows still a further embodiment of a performance traffic management module operating in a circuit switched domain. As shown, module 1400 includes an analysis module 1402, for providing alert information to the manager 450 through the interface 404, and a reference data service module 1404, for providing reference data to the system through the interface 404. Also included within the module 1400 are a database 1406 for storing reference data and alert information and data collectors 1408. As with the other components described herein, the module 1400 may otherwise be connected to a variety of network elements, the configuration and function of which are well known in the art. For example, data collector 1408 may communicate with switches 1420, 1422, 1424, 1426, and 1428. Of course, other switches or network elements may be connected thereto.

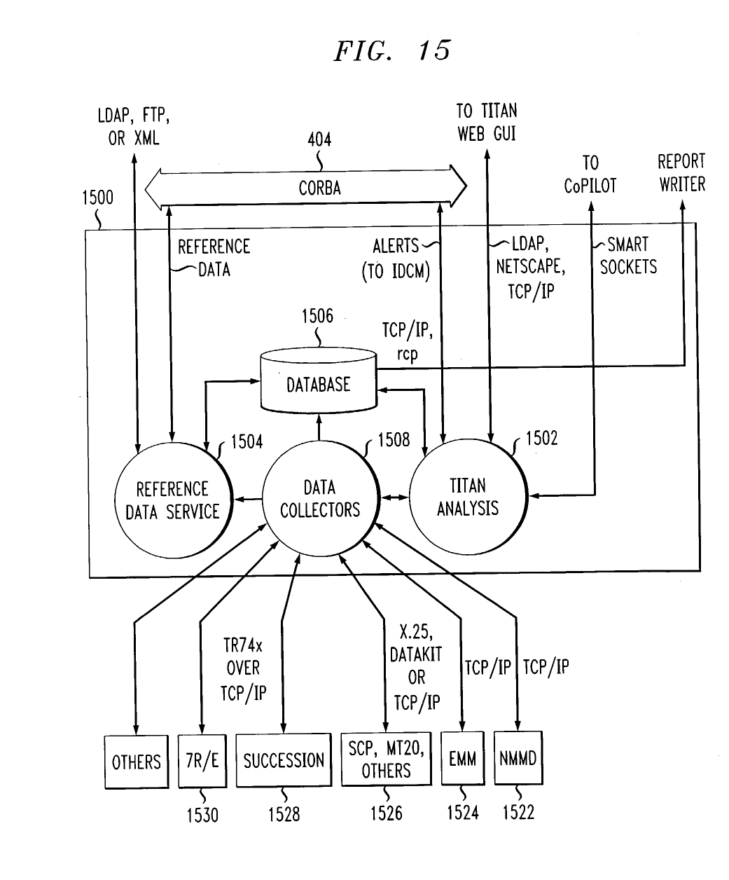

Referring to FIG. 15, a still further embodiment of a performance traffic management module operating in a circuit switched domain is illustrated. In this regard, a module 1500 includes an analysis module 1502, providing alerts to the manager 450, and a reference data service module 1504, providing reference data to the network through the interface 404. Also shown in the module 1500 are a database 1508 for storing reference data and alert information and data collectors 1508. Module 1500, through the data collectors 1508, may communicate with a variety of network components including element 1522, 1524, 1526, 1528, 1530, and others.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A traffic monitoring and congestion management system adaptable for use in a network across multiple communication domains communicating through an application program interface, the system comprising:
an input module in communication with the application program interface and operative to receive alert information from the multiple domains, the alert information being generated as a result of an irregularity in the network;
an analysis module operative to determine a root cause of the generation of the alert information based on a first predetermined set of rules;
an action determination module operative to determine an action based on the root cause and a second predetermined set of rules; and,
an interface module in communication with the application program interface and operative to convey the action to the network to resolve the irregularity.

2. The system as set forth in claim 1 further comprising a user interface operative to convey commands from a user to the system.

3. The system as set forth in claim 2 wherein the user interface comprises a module operative to generate periodic tables.

4. The system as set forth in claim 2 wherein the user interface comprises a module operative to display alert information.

5. The system as set forth in claim 2 wherein the user interface comprises a module operative to generate alert tables.

6. The system as set forth in claim 2 wherein the user interface comprises a module operative to generate reports.

7. The system as set forth in claim 2 wherein the user interface comprises a module operative to provide a common browser across the multiple communication domains.

8. The system as set forth in claim 2 wherein the user interface comprises a common reporting tool across the multiple communication domains.

9. The system as set forth in claim 1 wherein the first predetermined set of rules requires the analysis module to obtain information from network elements to determine the root cause.

10. The system as set forth in claim 1 wherein the second predetermined set of rules requires interaction of a user.

11. The system as set forth in claim 1 further comprising an integrated map construction module operative to construct a map based on the irregularity in the network.

12. The system as set forth in claim 1 further comprising a module operative to provide common operation, administration and maintenance across the multiple communication domains.

13. The system as set forth in claim 1 comprising a module operative to provide common schema for reference and user data among the multiple communication domains.

14. The system as set forth in claim 1 further comprising a module operative to provide common security data across the multiple communication domains.

15. A traffic monitoring and congestion management method for use in a network across multiple communication domains communicating through an application program interface, the method comprising steps of:
monitoring the multiple communication domains;
receiving alert information from the multiple communication domains through the application program interface, the alert information being generated as a result of an irregularity in the network;
determining a root cause of the generation of the alert information based on a first predetermined set of rules;
determining an action based on the root cause and a second predetermined set of rules; and,
conveying the action to the network to resolve the irregularity.

16. The method as set forth in claim 15 further comprising constructing a map based on the irregularity in the network.

17. The method as set forth in claim 15 further comprising providing common operation, administration and maintenance across the multiple communication domains.

18. The method as set forth in claim 15 further comprising providing common schema for reference and user data among the multiple communication domains.

19. The method as set forth in claim 15 further comprising providing common security data across the multiple communication domains.

20. A traffic monitoring and congestion management system for use in a network across multiple communication domains, the system comprising:
means for monitoring the multiple communication domains;
means for receiving alert information from the multiple communication domains, the alert information being generated as a result of an irregularity in the network;
means for determining a root cause of the generation of the alert information based on a first predetermined set of rules;
means for determining an action based on the root cause and a second predetermined set of rules; and,
means for conveying the action to the network to resolve the irregularity.
